(19) United States
(12) Patent Application Publication
(10) Pub. No.: US 2006/0016765 A1
(43) Pub. Date: Jan. 26, 2006

(54) Water treatment

(76) Inventors: David George DiPietro, Mullica Hill, NJ (US); Carl W. Erkenbrecher JR., Elkton, MD (US); Madhusudan D. Jayawant, Hockessin, DE (US); Colleen D. Merritt, Wilmington, DE (US); Allen H. Rau, Cincinnati, OH (US); Richard Alan Reynolds, Middletown, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/116,485

(22) Filed: Apr. 28, 2005

Related U.S. Application Data
(60) Provisional application No. 60/589,726, filed on Jul. 21, 2004.

(51) Int. Cl. C02F 1/50

(52) U.S. Cl. 210/754; 210/764

(57) ABSTRACT

A composition and a process for using the composition to treat water for clarifying, sanitizing, or disinfecting water wherein the composition comprises an active oxygen compound and one or more precursors for generating chlorine dioxide (ClO₂), and the process comprises contacting water with a solid composition comprising an active oxygen compound and precursors for generating ClO₂ and is characterized in that, upon the contacting, at least 10 grams of the composition can be dissolved in about 3.8 liters of water at 25° C. in less than about 60 minutes, thereby generating a solution containing at least about 40 ppm ClO₂, is disclosed.

### FIELD OF THE INVENTION

The invention relates to a process for treating water employing a composition comprising an active oxygen compound and a precursor that generates chlorine dioxide.

### BACKGROUND OF THE INVENTION

Disinfection of water can be carried out by chlorination. However, when surface water is chlorinated, trihalomethanes are produced, such as chloroform, which are reportedly carcinogenic. Municipal water systems that exceed 100 parts per billion maximum trihalomethane level, set by the US Environmental Protection Agency (EPA), are required to switch to alternate disinfection systems.

Chlorine dioxide (ClO₂) can be used as an antimicrobial and/or deodorizing agent to treat water such as pools, spas, and other recreational and ornamental waters, but it can be toxic when misapplied. Great care must be exercised to keep any human or animal exposure down to a safe limit. As an alternative, metal chlorite salts may be employed, using acidification to generate ClO₂ under controlled conditions.

For example, patent application WO 03/055797 discloses a method for the production of ClO₂ mixed with oxygen by reacting a chlorite with peroxymonosulfate in an acidic aqueous solution in the presence of a redox initiator (such as a peroxodisulfate or oxalic acid). A chloride salt, preferably sodium chloride, and/or hydrogen sulfate may be added in order to accelerate the reaction at low temperatures. The application also discloses a kit for carrying out this reaction wherein one composition contains a chlorite and the second separate composition contains a peroxymonosulfate mixed with the redox initiator. In one embodiment, the two dry compositions may be in the form of two separate tablets. All examples show the introduction of the above two compositions separately into water having an elevated-temperature. This method of generating a mixture of ClO₂ and oxygen does not provide a single, easily dissolvable composition.

There is therefore a need for a single dosage package form that upon dissolution in water generates in a short period of time an aqueous solution containing active oxygen and a safe concentration of ClO₂ suitable for deodorizing and disinfecting purposes. It is desired to have an alternative for specialized and costly ClO₂ generating equipment by providing a pre-measured, convenient dosage which is easy-to-use and safe to handle and store, to deliver ClO₂ in solution at a consistently safe handling level, leaving behind no insoluble material. In addition, it is desired to eliminate the need to store quantities of sodium chlorite and acid for ClO₂ generation. The present invention provides such a single dosage composition for the efficient conversion of sodium chlorite to ClO₂.

### SUMMARY OF THE INVENTION

The invention comprises a process for treating water comprising a) contacting water with a solid composition wherein said composition comprises an active oxygen compound and one or more precursors for generating chlorine dioxide, b) dissolving said composition in said water at about 25° C. in less than about 60 minutes, and c) generating a solution containing at least about 40 ppm chlorine dioxide. Preferably said composition is in the form of tablet and said water includes pool water, spa water, or recreational and ornamental water and said recreational and ornamental water includes fountain water, reflecting pool water, or ornamental pond water.

The invention also comprises a composition comprising an active oxygen compound and one or more precursors for generating chlorine dioxide wherein said composition dissolves in water at about 25° C. in less than about 60 minutes generating a solution containing at least about 40 ppm chlorine dioxide.

The invention also comprises a composition which comprises by weight
a) from about 20% to about 90% of a sulfur-containing oxyacid;
b) from about 3% to about 25% of a soluble chlorite salt;
c) from about 3% to about 12% of an alkali metal halide or alkaline earth metal halide, or mixtures thereof;
d) from about 0.001 to about 37% of a filler;
e) from about 0.001 to about 5% of a carbohydrate; and
f) optionally, an alkali metal carbonate, alkaline earth metal carbonate, alkali metal bicarbonate, alkaline earth metal bicarbonate, or mixtures thereof; a binder; a lubricant; a punch face anti-adherent; a fragrance enhancer; an acid other than the oxyacid; or combinations of two or more thereof;
provided that a cation of said alkali metal halide, said alkaline earth metal halide, said alkali metal carbonate, said alkaline earth metal carbonate, said alkali metal bicarbonate, said alkaline earth metal bicarbonate, or said alkaline earth bicarbonate does not form a sulfate with solubility less than 1% in water.

The present invention further comprises a method for sanitizing or disinfecting water comprising a) contacting the water with a composition comprising an active oxygen compound and one or more precursors for generating chlorine dioxide, b) dissolving said composition in said water at about 25° C. in less than about 60 minutes, and c) generating a solution containing at least about 40 ppm chlorine dioxide.

### DETAILED DESCRIPTION OF THE INVENTION

Trademarks are indicated herein by capitalization. The term “tablet” as used herein means a compacted mass of solid material, usually compressed, molded, or extruded, of various physical forms such as a briquette, disk, block or unit. A tablet is characterized by having a sufficient hardness to resist breakage during handling.

The term “ppm” as used herein means micrograms per gram (μg/g).

The term “microorganism” as used herein refers to any noncellular or unicellular (including colonial) organism. Microorganisms include all prokaryotes. Microorganisms include bacteria (including cyanobacteria and Mycobacteria), lichens, fungi, mold, protozoa, virinos, viroids, viruses, and some algae. As used herein, the term “microbe” is synonymous with microorganism.

The term “antimicrobial” as used herein means an agent which destroys or incapacitates microorganisms, as well as inhibits the growth of microorganisms.

The term “sanitizer” as used herein means an agent which provides antimicrobial activity. US EPA standards require a 5-log kill of bacteria in 30 seconds.

The term “disinfectant” as used herein means an agent which provides antimicrobial activity. US EPA Standards require a 3 log kill of particular pathogenic bacteria in 10 minutes. These bacteria are S. aureus, P. aeruginosa and S. choleraesuis.

This invention relates to a composition and a process for treating water. The composition comprises an active oxygen compound and one or more chlorine dioxide-generating compounds. The process comprises contacting water with the composition, dissolving said composition, and generating at least 40 ppm chlorine dioxide in solution. At least 10 g, or 50 g, or even 100 g, of the composition is dissolved in at least about 3.8 liters of water in less than or equal to about 60 minutes, with the water at about 15 to about 50° C., preferably at about 20 to about 45° C., and more preferably at about 25° C., to generate a solution containing an active oxygen compound and chlorine dioxide. Preferably the composition is dissolved in less than or equal to about 50 minutes, more preferably in less than or equal to about 30 minutes, and even more preferably in less than or equal to about 25 minutes. The concentration of chlorine dioxide produced is greater than or equal to about 40 ppm. Preferably at least about 50 ppm of chlorine dioxide is generated, more preferably at least about 75 ppm, and more preferably at least about 100 ppm. Using an optimum composition and tableting conditions, a dissolution time of, or shorter than 20 minutes can be achieved, generating chlorine dioxide in solution at a concentration of at least 50 ppm.

Though any water can be treated, the process is preferably used to treat pools, spas, and other recreational and ornamental waters including for example fountains, reflecting pools, and ornamental ponds.

The composition used in the process of the present invention can be in any physical form such as for example, powder, gel, tablet, or combinations of two or more thereof and in any shape. For example, an easily dissolvable tablet is readily used for generating an aqueous solution of chlorine dioxide and active oxygen for use as a general purpose sterilizing agent and deodorant of water. The composition comprises an active oxygen compound and one or more (at least one) precursors for generating chlorine dioxide wherein said composition dissolves in water at about 25° C. in less than about 60 minutes generating a solution containing at least about 40 ppm chlorine dioxide. The composition of the present invention has the advantage that all ingredients or components are water-soluble, so that no insoluble residue is left behind on the disinfected surface.

Suitable active oxygen compounds are those that provide a source of active oxygen, and may also provide a source of sanitizing action. Preferred are sulfur-containing oxyacids such as peroxysulfuric acids and their salts. Examples include peroxymonosulfuric acid and peroxydisulfuric acids and their salts. Suitable precursors for generating chlorine dioxide include a soluble chlorite salt, an alkali metal salt or alkaline earth halide salt, and an acid.

Preferably the composition comprises, by weight percent, the following ingredients, provided that the percentages add up to 100%,
a) from about 20% to about 90% of a sulfur-containing oxyacid,
b) from about 3% to about 25% of a soluble chlorite salt, and
c) from about 3% to about 12% of an alkali metal halide or alkaline earth metal halide, provided that a cation of the alkali metal halide or alkaline earth metal halide does not form a sulfate with solubility less than 1% in 25° C. water,
d) about 0.001 to about 5% of a carbohydrate, such as a water-soluble starch or modified starch, and
e) from about 0.001 to about 37% of a filler, for example, an alkali metal (or alkaline earth metal) sulfate.

Optionally, the composition also comprises:
f) from about 0.001 to about 10%, or preferably 0.1% to about 5%, by weight of the composition, of an alkali metal carbonate, alkaline earth metal carbonate, alkali metal bicarbonate, or alkaline earth metal bicarbonate, provided that a cation of the metal carbonate or bicarbonate does not form a sulfate with solubility less than 1% in 25° C. water,
f) about 0.001 to about 15% of a water-soluble tablet binder, such as sugar alcohol, maltodextrin or corn syrup solids;
g) about 0.001 to about 5% of a lubricant, such as tablet lubricant, preferably water-soluble tablet lubricant;
h) about 0.001 to about 5% of a punch face anti-adherent, preferably a water-soluble punch face adherent;
i) about 0.001 to about 5% of a fragrance enhancer; or
j) about 0.001 to about 20% of an acid other than the oxyacid.

A major component of the composition comprises a sulfur-containing oxyacid (a), which both supplies the active oxygen and reacts with the soluble chlorite to generate chlorine dioxide. The sulfur-containing oxyacid comprises an alkali monopersulfate and/or dipersulfate such as potassium monopersulfate, or the triple salt of potassium monopersulfate, potassium hydrogen sulfate and potassium sulfate, which is approximately represented by the formula 2 KHSO₅.KHSO₄.K₂SO₄ and is available from the E. I. du Pont de Nemours and Company, Wilmington, Del., under the trade name of OXONE. It is present in the composition in the amount of from about 20% to about 90%, or about 20% to about 80%, or from about 20% to about 75%, or about 23%, by weight.

The composition also comprises a soluble chlorite salt (b), which can react with the oxyacid in water to generate chlorine dioxide. Examples of such soluble chlorite salts include alkali metal or alkaline earth metal salts. More preferably the soluble chlorite salt is sodium chlorite. It is present in the composition in the amount of from about 3% to about 25%, or preferably from about 3% to about 20%, by weight.

The composition further comprises an alkali metal halide or alkaline earth metal halide (c), with the proviso that its cation does not form a sulfate with solubility less than 1% in 25° C. water. The halide salt is preferably selected from the group consisting of magnesium chloride, sodium chloride, zinc chloride, zinc bromide and combinations of two or more thereof. More preferably, the soluble halide is magnesium chloride. The halide salt can act as a catalyst to speed up the generation of chlorine dioxide. When certain halide salts are used, such as magnesium chloride, they can also provide a local heating effect due to their heat of solution, thus also promoting the tablet dissolution and chlorine dioxide generation. The halide sale is present in the tablet in the amount of from about 3% to about 12%, or preferably about 5% to about 10%, or more preferably about 8%, by weight.

The composition further comprises from about 0.001 to about 5%, or preferably about 1% to about 3%, or more preferably about 1 to about 2%, by weight of a carbohydrate (d) such as water-soluble starch or modified starch. Any available such starch may be used including starches derived from corn, wheat, soy, rice, potato, or cellulose. The starch can provide an entry point for water and so aids the tablet's dissolution in water.

The composition can further comprise a filler (e). A variety of fillers are suitable for use such as, for example, an alkali metal (or alkaline earth metal) sulfate in the range of from about 0.001 to about 37% by weight. Potassium sulfate and sodium sulfate are examples of such filler.

The composition also optionally further comprises an alkali metal carbonate or bicarbonate or alkaline earth metal carbonate or bicarbonate (g), with the proviso that its cation does not form a sulfate with solubility less than 1% in water at about 25° C. Examples include sodium bicarbonate, sodium carbonate, potassium bicarbonate, potassium carbonate, magnesium bicarbonate, magnesium carbonate, and combinations of two or more thereof. Preferably, it is sodium bicarbonate. It can be present in the amount of from about 0.001% to about 10%, or preferably from about 0.01% to about 10%, or more preferably from about 0.1 to about 10%, by weight of the composition. Wishing not to be bound by theory, in addition to its effect in adjusting solution pH, it is believed that carbonate or bicarbonate reacts in an aqueous acid medium to generate carbon dioxide and a resulting effervescence, thus further promoting dissolution of the composition.

The composition optionally comprises 0.001 to about 15% of a binder such as water-soluble tablet binder (g), to increase the tablet solubility in water and act as a tableting binder to increase the hardness of the tablet. Any available such binder may be used. A binder such as a sugar alcohol, maltodextrin or corn syrup solids is preferred. Preferably, the binder is a sugar alcohol. More preferably, the sugar alcohol is sorbitol. The tablet binder can be present in the amount of from about 1% to about 10%, or preferably from about 4 to about 5%, by weight.

The composition also optionally comprises about 0.001 to about 5% by weight of, for example, a tablet lubricant (h) including polyethylene glycol, sodium benzoate, stearates such as magnesium stearate, sucrose stearate, and the like, mineral oil, and silicone lubricants. Lubricant and compression aids can ensure good release of a solid such as tablet from the tablet die and are well known in the art. For example, a water-soluble polyethylene glycol in an amount of from about 1% to about 2% by weight can be used. Preferably, it has a molecular weight of about 3000 to about 10000, or more preferably from about 3000 to about 9000, or more preferably from about 7000 to about 9000, such as polyethylene glycol 180 (PEG 180, available from Dow Chemicals, Midland, Mich.). The lubricant can also act on the sidewall during the tableting process thereby helping avoid maintenance problems with the tableting equipment and insure proper tablet release and tablet integrity.

The composition also optionally contains about 0.001 to about 5%, or preferably 1 to about 2%, by weight of a punch face anti-adherent (i). Preferred is a water-soluble punch face anti-adherent such as sodium benzoate. This aids in, for example, a tableting process by providing a top and bottom punch face lubricant. This helps avoid maintenance problems with the tableting equipment and helps insure proper tablet release and tablet integrity.

The composition also optionally contains 0.001 to about 5%, or 0.001 to about 0.5%, by weight of a fragrance enhancer (j). Any available fragrance enhancer, especially one that is stable in the presence of oxidizing agents, may be used.

The composition also optionally contains about 0.001 to about 20% by weight of a co-acid (k), an acid other than the oxyacid, to adjust the solution pH to from about 2.5 to about 5.0, if necessary, for optimum generation of ClO₂. The co-acid can be adipic acid, malic acid, sulfamic acid, citric acid, tartaric acid, sodium bisulfate, or combinations of two or more thereof.

The composition can be readily dissolved in water at temperatures of from about 15 to about 50° C. For example, swimming pool water can be at various temperatures. The time required for a particular composition to dissolve in water may vary depending on, for example, such factors as the physical form, size, number, and shape of the composition, its surface and interior hardness, its surface roughness or glaze, its moisture content, the dissolving water temperature, the amount of water, the degree of stirring, the particle size of the individual components in the blend and the uniformity of the blend, and the like.

Any methods known to one skilled in the art such as, for example, mixing, kneading, blending, pelleting, tableting, or extruding can be used to produce the composition. Tableting is disclosed herein as an example. The process for making the composition is carried out under any suitable means such as ambient temperature and pressure for about one minute to about several hours. For example, tableting can be used to produce tablets that can dissolve readily in water, yet have sufficient hardness to reduce breakage during packaging and handling, detailed description of such methods is omitted herein for the interest of brevity. For example, components can be weighed, sieved to reduce the size of agglomerates (if any), physically combined and mixed, for example using a Hobart mixer to make a blend. A fragrance, if present, can be typically premixed with one or more of the other components to reduce loss and ease blending. The blend can be fed into a tablet press, for example a Stokes DD2 rotary press available from DT Converting Technologies, 400 Kidd's Hill Road, Hyannis, Mass. The press can be adjusted to deliver tablets of the desired size and hardness.

The present invention further comprises a method for clarifying, sanitizing, or disinfecting water, which comprises contacting the water with a composition as described above comprising an active oxygen and one or more precursors for generating ClO₂, dissolving said composition, and generating a solution containing at least 40 ppm of chlorine dioxide. The method reduces or eliminates cloudiness or opaqueness of the water to achieve clarity. The method also sanitizes and disinfects the water in that the composition acts as an antimicrobial agent. The water temperature, the dissolution time and the resulting chlorine dioxide concentration are as disclosed above for the process for treating water of the present invention.

The following examples are illustrative, but are not to be construed to unduly limit the scope, of the invention.

Analyses

The chlorine dioxide concentrations and active oxygen were determined as follows. A tablet was first dissolved in 3.785 liters of deionized water. The chlorine dioxide concentrations were measured using a Hach DR/890 Series Colorimeter and the Hach Method 8345, available from The Hach Company, P.O. Box 389, Loveland, Colo. 80539. To determine the ppm of active oxygen due to chlorine dioxide, abbreviated as “ppm AO (ClO₂)”, the above result was multiplied by 0.593.

The ppm of active oxygen due to OXONE, abbreviated as “ppm AO (OXONE)”, was determined as follows. First, the total active oxygen content of the above solution was determined. A tablet was dissolved in 3.785 liters of deionized water. To a 50 g sample of the solution, 10 ml of 20% sulfuric acid and 10 ml of 25% potassium iodide were added. The solution was then titrated with sodium thiosulfate as disclosed in the DuPont technical bulletin for OXONE, available from E. I. du Pont de Nemours and Company, Barley Mill Plaza 23, 4417 Lancaster Pike, Wilmington, Del. 19805, and on the Internet at “http://www.dupont.com/oxone/techinfo/”. This value was then corrected by deducting the ppm AO (ClO₂) as determined above, to determine the ppm AO (OXONE).

### EXAMPLE 1

Sample tablets were produced. Every 100 g of the tablets comprised OXONE (72.6 g), magnesium chloride (8 g), sorbitol (4 g), sodium chlorite (5 g), sodium bicarbonate (5 g), starch (2.6 g), polyethylene glycol PEG-180 (1.5 g), sodium benzoate (0.9 g), and fragrance (0.4 g). The ingredients were weighed out using a large, floor scale. Pre-milled sodium chlorite having reduced particle size and a fragrance were mixed with sorbitol to ease transfer, and an overall 10-kg mixture was blended using a “kitchen style” Hobart mixer with a paddle for 10 minutes. The blended powder was fed into a Stokes DD2 rotary press. The tablet “hardness” was 5 indicating a minimum hardness for commercial packaging purposes. The tablets were sized for an approximate weight of 2.6 g per tablet.

When tested by dissolving in 26° C. water, the tablet dissolution time was under 5 minutes. The tablets, which initially had 27 ppm ClO₂ and 766 ppm OXONE (37 ppm AO (OXONE) and 16 ppm AO (Cl₂)), were tested for stability. After 5 weeks at room temperature, the tablets had 27.3 ppm ClO₂ and 860 ppm OXONE (41 ppm AO (OXONE) and 16 ppm AO (ClO₂)) indicating that the composition was very stable. Three sample tablets were made having a hardness of 5, 6.5, and 11. Dissolution test of the tablets (5 g each) showed that the one with hardness 5 dissolved (3.785 liters of water) in about 5 minutes generating about 27 ppm ClO2 while the one having hardness 11 also dissolved in about 5 minutes and generated about 11.5 ppm ClO₂.

A series of tablets having 5 g each and the same composition was also made under different pressure from 1250 pounds to 20000 pounds. All tablets dissolved in 3.785 liters of water at about 25-27° C. in about 9 minute (tablets made under 1250 pounds) to about 20 minutes (tablets made under 20000 pounds) indicating the chemical performance of the tablets was very constant regardless of tableting pressure, and that the only noticeable effect was on dissolution time, particularly at the lower end of the pressure scale.

### EXAMPLES 2 TO 6 AND COMPARATIVE EXAMPLES A TO D

A series of tablets (2.6 g each) were produced as in Example 1 except that equal amounts of various chemicals were substituted for the magnesium chloride. As shown in Table 1, only halide salts produced ClO₂ greater than 10 ppm and magnesium chloride appeared superior to the other halides tested. Zinc chloride and zinc bromide compositions were also satisfactory.

TABLE 1

| | MgCl₂ or | Water | Dissolution | | ClO₂ | ClO₂ | | |
|---|---|---|---|---|---|---|---|---|
| Ex. | replace- | temp | time | | ppm (test | ppm (test | ClO₂ AO | OXONE |
| No. | ment | ° C. | (min.) | pH | 1¹) | 2¹) | ppm | ppm |
| 2 | MgCl₂ | 25 | 8 | 4.5 | 11.8 | 12.9 | 7 | 47 |
| A | CaCl₂ | 25 | 60² | 3.4 | 2.1 | 3.4 | 1 | — |
| B | CaCl₂ | 26 | 60 | NM³ | 13.8 | 13.9 | 8 | — |
| | (2 trials) | — | 60+ | | 16.6 | — | 10 | — |
| C | CaBr₂ | 24 | 20⁴ | 3.7 | 11.3 | 11.6 | 7 | 44 |
| | | 27 | 60+ | 3.5 | 4.3 | — | 3 | 42 |
| 3 | ZnCl₂ | 25 | 24 | 3.6 | 17.6 | 18.3 | 10 | 47 |
| | (2 trials) | 26 | 20 | 3.8 | 14 | 19 | 8 | 48 |
| 4⁵ | ZnBr₂ | 27 | 25 | 4.1 | 21.1 | 21.7 | 13 | 39 |
| | (2 trials) | 27 | 30 | 4.2 | 19.2 | — | 11 | 37 |
| D | Na₃PO₄ | 27 | 15 | 6.1 | 7.3 | — | 4 | 50 |
| | (2 trials) | 25 | 14 | 5.9 | 7.5 | — | 4 | 48 |
| 5 | FeCl₃ | 25 | 12 | 3 | 42.9⁶ | — | 25 | 32 |
| 6 | NaCl | 26 | 10 | 5.3 | 11.8 | 12.8 | 7 | 50 |

¹The time that the ClO₂ testing was carried out depended on the rate of tablet dissolution and varied accordingly.
²If the tablet was not completely dissolved at the end of 60 minutes, the experiment was halted.
³NM, not measured.
⁴First run was stirred.
⁵Both runs were stirred
⁶Ferric chloride testing was discontinued due to the yellow color which apparently interfered with the ClO₂ test. The calcium bromide also gave an orange color which may have interfered with results.

### EXAMPLES 7-9

Test tablets were produced using the composition of Example 1 except that potassium or sodium persulfate was substituted for the OXONE. Five grams of the mixture was made into 3 tablets of approximately the same size using a Carver press. The tablets were placed in a gallon (3.785 liters) of water and allowed to dissolve. As shown in Table 2, both sodium persulfate and potassium persulfate generated ClO₂ in solution.

TABLE 2

| | Example 7 | Example 8 | Example 9 |
|---|---|---|---|
| | OXONE | Potassium persulfate | Sodium persulfate |
| Water Temp | 26 C | 27 C | 24 C |
| pH | 4.4 | 6.8 | 6.8 |
| Tablet Weight | 5 | 5.02 | 4.96 |
| Dissolution Time | 5 minutes | 60 minutes | 30 minutes |
| ppm ClO2 | 27 ppm | 11 ppm | 16 ppm |
| ppm OXONE | 766 ppm | NA | NA |
| ppm AO OXONE | 37 ppm | NA | NA |
| ppm AO ClO2 | 16 ppm | 6.5 ppm | 9.5 ppm |

NA = not available

### EXAMPLE 10, COMPARATIVE EXAMPLE A

All tablets were produced as in Example 1. A 50 g batch was made and 10 g were removed and pressed into a tablet on the Carver press for each example. The results are shown in Table 3 below.

TABLE 3

| Ingredient (g) | Comp. A | 10-1 | 10-2 | 10-3 | 10-4 | 10-5 |
|---|---|---|---|---|---|---|
| Oxone | 2 | 2.4 | 2.35 | 2.5 | 2.3 | 2.3 |
| Magnesium chloride | | 0.8 | 0.75 | 0.8 | 0.8 | 0.8 |
| Sodium chlorite | 1.5 | 1.5 | 1.5 | 1.5 | 2 | 2.5 |
| Sorbitol | | | | | | 0.5 |
| Starch-food grade | | | 0.1 | 0.26 | 0.18 | 0.18 |
| PEG 180 | | | 0.1 | 0.15 | 0.15 | 0.15 |
| Sodium benzoate | | | 0.05 | 0.06 | 0.06 | 0.15 |
| Sodium Sulfate | 6.5 | 5.3 | 5.15 | 4.73 | 4.51 | 3.42 |
| ClO₂reading | 42.3 | 9.9 | 7.9 | 8.1 | 8.6 | 10.1 |
| Dilution | | 1:10 | 1:10 | 1:10 | 1:10 | 1:10 |
| Adjusted ClO₂ in ppm | | 99 | 79 | 81 | 86 | 101 |
| Temp (° F.) | 80 | 80 | 80 | 80 | 80 | 80.0 |
| Time (minutes) | >60 | >50 | 18 | 14 | 20 | 20 |

Table 3 shows that without magnesium chloride, the tablets made did not dissolve in water within the desired period of time.

### EXAMPLE 11

Tablets were prepared as described above having the formulation of Example 1. A solution was prepared by dissolving two tablets in 2 gallons (about 3.5 liters) of deionized water and tested for microbial efficacy.

Inoculum Prep: Test bacteria included Staphylococcus aureus ATCC 6538, Pseudomonas aeruginosa ATCC 15442, and Salmonella choleraesuis ATCC 10708. Modified AOAC protocol 965.13 was used in which each culture was transferred daily for three days on TRYPTICASE Soy Agar (TSA). A suspension was made of each bacterium by adding 5 ml of sterile Butterfield buffer (BB) to the TSA plate and suspending the colonies using a sterile L-shaped inoculating rod. This was removed to a sterile Nephalo flask. Another 5 ml of BB was added to the plate, the plate swirled and resulting suspension added to the same Nephalo flask. A Klett reading was taken and the suspension further diluted with BB to give a Klett reading of about 24-29 (˜89% T; this is equivalent to ˜1.0E+08 CFU/ml). Stock inocula were further diluted 1:100 to provide densities as shown in Table 4.

Test System: A 0.1 ml aliquot of test inoculum was added to 9.9 ml of test substance, the tube mixed and a timer started. After the 10-min exposure time, a serial-dilution plate count was done on TSA. D/E (Dey/Engley) Neutralizing Broth (available from Becton Dickinson, Billerica, Mass.) was used for neutralization in the first serial-dilution tube. An inoculum control was also run by adding 0.1 ml of the test inoculum to 9.9 ml of BB and plated on TSA after the 10-min exposure time. All plates were incubated at 35° C. for 18-24 h, colonies counted and densities calculated. To verify neutralization, one colony from a 24-h TSA plate was added to a 9.9 ml BB tube and from this tube a 1 μl loopful was inoculated into each Dey/Engley tube exhibiting no growth. A 0.1 ml aliquot was plated on TSA, incubated at 35° C. for 48 h and colonies counted. The 0.1 ml aliquot plated onto TSA plate resulted in approximately 200 colonies per plate. This was done for each test bacterium.

A ClO₂ control solution was prepared in filter-sterilized MILLIPORE water using Anthium Dioxide (stabilized sodium chlorite available from IDI, North Kingston, R1) acidified with concentrated HCl. ClO₂ concentrations of the prepared solution were measured using a 0-50 ppm Hach kit. Triplicate measurements were made: (1) 23.2 mg/l, (2) 23.0 mg/l, and (3) 23.5 mg/l and the average ClO₂ concentration was 23.2 ppm. The results are shown in Table 4.

TABLE 4

| | Plate Counts @ Dilution | Stock Inoculum Density |
|---|---|---|
| S. aureus | 102/108@ -5 | 1.1E+08 CFU/ml |
| P. aeruginosa | 39/44@ -5 | 4.2E+07 CFU/ml |
| S. choleraesuis | 144/154@ -5 | 1.5E+08 CFU/ml |

The density of bacteria challenged and the bacterial efficacy results are shown below in Table 5A-5C for each bacterium. In Tables 4, 5A, 5B and 5C, the notation of E plus or minus two digits means an exponent for which the two digits indicate the power of 10 by which the number preceding the E is multiplied. For example, 1.1E+08 is 1.1×10⁸.

TABLE 5A

| Exposure | | Plate Count | | | Dilution | | |
|---|---|---|---|---|---|---|---|
| Time | Description | Rep A | Rep B | Mean | Factor | CFU/ml* | Δt |
| NA | Uninoculated Control | 0 | 0 | 0 | 1 | 0.00E + 00 | NA |
| 30 sec | Inoculum: S. aureus | 90 | 181 | 136 | 0.001 | 1.36E + 06 | NA |
| | Example 11 = 1,008 ppm | | | | | | |
| 30 sec | Oxone + 55.5 ppm Chlorite | 0 | 0 | 0 | 1 | 1.00E + 01 | 5.1 |
| 30 sec | 1,008 ppm Oxone control | 145 | 159 | 152 | 0.001 | 1.52E + 06 | 0.0 |
| 30 sec | 55.5 ppm Chlorite control | 109 | 136 | 123 | 0.001 | 1.23E + 06 | 0.0 |
| 30 sec | 23.2 ppm ClO2 control | 0 | 0 | 0 | 1 | 1.00E + 01 | 5.1 |
| 10 min | Inoculum: S. aureus | 157 | 164 | 161 | 0.001 | 1.61E + 06 | NA |
| | Example 11 = 1,008 ppm | | | | | | |
| 10 min | Oxone + 55.5 ppm Chlorite | 0 | 0 | 0 | 1 | 1.00E + 01 | 5.2 |
| 10 min | 1,008 ppm Oxone control | 60 | 63 | 62 | 0.001 | 6.15E + 05 | 0.4 |
| 10 min | 55.5 ppm Chlorite control | 113 | 126 | 120 | 0.001 | 1.20E + 06 | 0.1 |
| 10 min | 23.2 ppm ClO2 control | 0 | 0 | 0 | 1 | 1.OOE + 01 | 5.2 |
| 10 min | Inoculum: S. aureus - pH 4.5 | 135 | 162 | 149 | 0.001 | 1.49E + 06 | NA |
| | Buffer | | | | | | |

*low level of detection is 1.0E + 01 CFU/mL (CFU = colony forming units)
Δt is log difference test and control densities
NA= not applicable

TABLE 5B

| Exposure | | Plate Count | | | Dilution | | |
|---|---|---|---|---|---|---|---|
| Time | Description | Rep A | Rep B | Mean | Factor | CFU/ml* | Δt |
| NA | Uninoculated Control | 0 | 0 | 0 | 1 | 0.00E + 00 | NA |
| 30 sec | Inoculum: P. aeruginosa | 95 | 108 | 102 | 0.001 | 1.02E + 06 | NA |
| | Example 11 = 1,008 ppm | | | | | | |
| 30 sec | Oxone + 55.5 ppm Chlorite | 0 | 0 | 0 | 1 | 1.00E + 01 | 5.0 |
| 30 sec | 1,008 ppm Oxone control | 71 | 119 | 95 | 0.001 | 9.50E + 05 | 0.0 |
| 30 sec | 55.5 ppm Chlorite control | 104 | 129 | 117 | 0.001 | 1.17E + 06 | −0.1 |
| 30 sec | 23.2 ppm ClO2 control | 0 | 0 | 0 | 1 | 1.00E + 01 | 5.0 |
| 10 min | Inoculum: P. aeruginosa | 127 | 128 | 128 | 0.001 | 1.28E + 06 | NA |
| | Example 11 = 1,008 ppm | | | | | | |
| 10 min | Oxone + 55.5 ppm Chlorite | 0 | 0 | 0 | 1 | 1.00E + 01 | 5.1 |
| 10 min | 1,008 ppm Oxone control | 0 | 0 | 0 | 1 | 1.00E + 01 | 5.1 |
| 10 min | 55.5 ppm Chlorite control | 105 | 136 | 121 | 0.001 | 1.21E + 06 | 0.0 |
| 10 min | 23.2 ppm ClO2 control | 0 | 0 | 0 | 1 | 1.00E + 01 | 5.1 |
| 10 min | Inoculum: P. aeruginosa - pH 4.5 | 114 | 118 | 116 | 0.001 | 1.16E + 06 | NA |
| | Buffer | | | | | | |

*low level of detection is 1.0E + 01 CFU/mL (CFU = colony forming units)
Δt is log difference test and control densities
NA= not applicable

TABLE 5C

| Exposure | | Plate Count | | | Dilution | | |
|---|---|---|---|---|---|---|---|
| Time | Description | Rep A | Rep B | Mean | Factor | CFU/ml* | Δt |
| NA | Uninoculated Control | 0 | 0 | 0 | 1 | 0.00E + 00 | NA |
| 30 sec | Inoculum: S. choleraesuis | 137 | 144 | 140.5 | 0.001 | 1.41E + 06 | NA |
| | Example 11 = 1,008 ppm | | | | | | |
| 30 sec | Oxone + 55.5 ppm Chlorite | 0 | 0 | 0 | 1 | 1.00E + 01 | 5.1 |
| 30 sec | 1,008 ppm Oxone control | 209 | 218 | 213.5 | 0.001 | 2.14E + 06 | −0.2 |
| 30 sec | 55.5 ppm Chlorite control | 306 | 312 | 309 | 0.001 | 3.09E + 06 | −0.3 |
| 30 sec | 23.2 ppm ClO2 control | 0 | 0 | 0 | 1 | 1.00E + 01 | 5.1 |
| 10 min | Inoculum: S. choleraesuis | 200 | 241 | 220.5 | 0.001 | 2.21E + 06 | NA |
| | Example 11 = 1,008 ppm | | | | | | |
| 10 min | Oxone + 55.5 ppm Chlorite | 0 | 0 | 0 | 1 | 1.00E + 01 | 5.3 |
| 10 min | 1,008 ppm Oxone control | 29 | 30 | 29.5 | 0.1 | 2.95E + 03 | 2.9 |
| 10 min | 55.5 ppm Chlorite control | 115 | 138 | 126.5 | 0.001 | 1.27E + 06 | 0.2 |
| 10 min | 23.2 ppm ClO2 control | 0 | 0 | 0 | 1 | 1.00E + 01 | 5.3 |
| 10 min | Inoculum: S. choleraesuis - | 199 | 209 | 204 | 0.001 | 2.04E + 06 | NA |
| | pH 4.5 Buffer | | | | | | |

*low level of detection is 1.0E + 01 CFU/mL (CFU = colony forming units)
Δt is log difference test and control densities
NA= not applicable

The tablet of the invention dissolved in 2 gallons (about 7.6 liters) of water was very effective in killing all bacteria with a □ 5-log reduction in 30 sec. For S. aureus, this level of activity was probably attributed to the generation of ClO₂ (23.2 ppm) in solution because the ClO₂ control also demonstrated the same level of kill in 30 sec (see Table 5A). Similarly for P. aeruginosa, the 5-log kill was probably attributed to the generation of ClO₂ in the 30-sec exposure even though efficacy from OXONE alone at 1,008 ppm was also demonstrated at the 10-min exposure (see Table 5B). The ClO₂ control at 30 sec demonstrated complete kill (i.e., 5-log reduction). OXONE at 10 min, on the other hand, also demonstrated complete kill (i.e., 5.1-log reduction). For S. choleraesuis, this level of activity was also probably attributed to the generation of ClO₂ in the 30-sec exposure which demonstrated complete kill (i.e., 5.1-log reduction). Some efficacy (i.e., 2.9-log kill) from OXONE alone at 1,008 ppm was demonstrated at the 10-min exposure (see Table 5C).

### EXAMPLE 12

This assay had several modifications from the published AOAC Fungicidal Activity of Disinfectants Protocol, Method 955.17. Aspergillus fumigatus ATCC 1098 was grown on Malt Extract Agar (available from Becton Dickinson, Billerica, Mass.) plates, and spores were harvested. Spores were stored in filter-sterilized Millipore water at −20° C. The spore preparation used for this experiment is detailed below. A freezer stock of A. fumigatus was defrosted and diluted to obtain an inoculum suspension for this experiment. The inoculum preparation was estimated to be approximately 5×10⁶ conidia/ml. The following test solutions were prepared using filter-sterilized MILLIPORE water in steam-sterilized 4 L bottles:

Water Control: (filter-sterilized water only), pH 6.28.

OXONE Control: 3.78 g OXONE in 1 gallon (about 3.8 liters) sterile water, buffered to pH 4.43 using 0.98 g NaHCO₃ and 5.25 g 10% H₂SO₄.

Chlorite Control: 0.26 g of sodium chlorite in 1-gallon sterile water buffered to pH 4.55 (1.8 g 10% H₂SO₄).

Buffer Control: sodium bicarbonate, pH adjusted to 4.4.

Chlorine Dioxide: Anthium Dioxide (stabilized sodium chlorite available from IDI, North Kingston, R1) was acidified with HCl.

CLOROX control: 4.17% (v/v) CLOROX bleach available from Clorox Company, Oakland, Calif. (v/v) in MILLIPORE water by mixing 4.17 ml of Clorox bleach and water up to 100 ml total volume.

Tablet test Solution (Example 12: 2 tablets of Example 1 were dissolved in one gallon (about 3.8 liters) of deionized water. The total tablet weight was 5.13 g. The pH of the resulting solution was 5.2.

Reaction tubes: 5 ml of each test solution was aliquoted into 25×150 mm test culture tubes, capped and labeled according to Table 6. 9 ml of D/E (Dey/Engley) Neutralizing Broth (available from Becton Dickinson, Billerica, Mass.) was added to each of 28 test tubes and the tubes were capped. Butterfield buffer blanks were arranged for dilution of neutralized samples, and Malt Extract Agar plates were numbered for spore enumerations of the diluted, neutralized samples. With a graduated pipette, 0.5 ml of spore inoculum (about 106 condia/ml) was added to the first tube of test solution and gently shaken. After 5- and 15-minute exposures to the respective test solutions, samples were gently shaken and 1 ml samples were removed from each reaction mixture (spore-test solution) using an Eppendorf pipette and placed in 9 ml D/E (Dey/Engley) Neutralizing Broth. The inoculum was further diluted to approximately 10⁴ condia/ml. Two more reaction tubes (water and OXONE-chlorite) and four Dey/Engley neutralization tubes were prepared to evaluate the efficacy of the tablet solution versus a final inoculum density of 10⁴ condia/ml in the reaction tube. Samples were reacted for 15 minutes only. Dilutions of neutralized samples were prepared. Two 100 μl aliquots of all samples in D/E (Dey/Engley) Neutralizing Broth were plated on Malt Extract Agar and incubated at 25° C. until the appearance of colonies. Plates were counted after colonies appeared, roughly 4 days after incubation. Several dilutions of the inoculum spore suspensions were also plated on Malt Extract Agar to obtain an accurate count of viable spores used as inoculum. The samples were incubated at 25° C. and counted after the appearance of colonies, after about 4 days of incubation.

A. fumigatus spores were inoculated into the controls and test solutions to a final density of about 5.6-6.25×10⁵ conidia/ml, confirmed by the water and buffer controls. The inoculum solution was also plated, counted, and the count was multiplied the volume (0.5 ml) added to the controls and test solutions to estimate density; 2.57×10⁵ conidia/ml inoculum density corresponded well with the water and buffer controls. Buffer control data was taken after 15 minutes. CLOROX control data was taken after 5 minutes of treatment.

Results indicated that the tablets of the invention, ClO₂ (about 23 ppm), and 4.17% CLOROX solution were capable of killing 5-log A. fumigatus spores within 5 minutes; ClO₂ and CLOROX were controls. Separately, OXONE control and chlorite control were not able to reduce the bioburden within 15 minutes of treatment.

Efficacy is affected by the bioburden density and organic soils. A lower density inoculum was prepared, about 6.7×10³ conidia/ml, and challenged with the tablet test solution (2 tabs/gallon) for 15 minutes. This test was performed in the event that the higher inoculum density (105 conidia/ml) was not affected by the treatment. The tablet test solution of Example 12 treatment killed this lower inoculum as well.

A solution of the tablets of the present invention was capable of completely killing all A. fumigatus spores (5-6×1 conidia/ml) within 5 minutes. Controls indicated that OXONE solution and sodium chlorite solution, equivalent to amounts found in the tablet solution, were ineffective in reducing the fungal bioburden. Chlorine dioxide solution was prepared as a control in the same concentration as that generated by tablets; 23 ppm ClO₂ solution was also capable of completely killing A. fumigatus inoculum within 5 minutes.

The tablet solution of Example 12 generated sufficient ClO₂ to completely kill the inoculum. The independent components of the tablet, i.e., OXONE and sodium chlorite solutions separately, were not capable of reducing the bioburden, whereas the result of their reaction in solution is strongly fungicidal versus A. fumigatus. The results are shown in Table 6.

TABLE 6
Surviving Bioburden Counts (germinating spores, conidia/ml)

| | 1 × 10⁵ conidia/ml inoculum in reaction mix, 2 replicates average | | | | | | |
|---|---|---|---|---|---|---|---|
| | | | Example | | | | |
| | | | 12- | | | | |
| | Water | Buffer | 2 Tabs, | | | Chlorine | |
| Time | pH 6.28 | pH 4.4 | 3.8 L | Oxone | Chlorite | Dioxide | CLOROX |
| 5 min | 5.60E + 05 | not tested | 0.00E + 00 | 3.45E + 05 | 4.25E + 05 | 0.00E + 00 | 0.00E + 00 |
| stdevp | 1.00E + 04 | not tested | 0.00E + 00 | 7.25E + 04 | 1.43E + 05 | 0.00E + 00 | 0.00E + 00 |
| 15 min | 6.25E + 05 | 6.00E + 05 | 0.00E + 00 | 5.70E + 05 | 6.25E + 05 | 0.00E + 00 | not tested |
| stdevp | 6.50E + 04 | 1.13E + 05 | 0.00E + 00 | 7.50E + 04 | 5.25E + 04 | 0.00E + 00 | not tested |

| | 1 × 10³ conidia/ml inoculum in reaction mix, 2 replicates average | |
|---|---|---|
| Time | Water pH 6.28 | Example 12-2 Tabs/3.8 L |
| 15 min | 6.70E + 03 | 0.00E + 00 |
| stdevp | 6.25E + 02 | 0.00E + 00 |

Inoculum verification conidia/ml, 1 replicate

| Time | 1 × 10⁵ inoculum | 1 × 10⁵ inoculum |
|---|---|---|
| 5 min | 2.57E + 05 | 3.77E + 03 |

What is claimed is:

1. A process for treating water comprising a) contacting water with a solid composition wherein said composition comprises an active oxygen compound and one or more precursors for generating chlorine dioxide, b) dissolving said solid composition in said water at about 25° C. in less than about 60 minutes, and c) generating a solution containing at least about 40 ppm chlorine dioxide.

2. The process of claim 1 wherein said composition comprises, by weight,
a) from about 20% to about 90% of a sulfur-containing oxyacid;
b) from about 3% to about 25% of a soluble chlorite salt;
c) from about 3% to about 12% of an alkali metal halide or alkaline earth metal halide, or mixtures thereof;
d) from about 0.001 to about 37% of a filler;
e) from about 0.001 to about 5% of a carbohydrate; and
f) optionally, an alkali metal carbonate, alkaline earth metal carbonate, alkali metal bicarbonate, alkaline earth metal bicarbonate, or mixtures thereof; a binder; a lubricant; a punch face anti-adherent; a fragrance enhancer; an acid other than the oxyacid; or combinations of two or more thereof;
provided that a cation of said alkali metal halide, said alkaline earth metal halide, said alkali metal carbonate, said alkaline earth metal carbonate, said alkali metal bicarbonate, said alkaline earth metal bicarbonate, or said alkaline earth bicarbonate does not form a sulfate with solubility less than 1% in water.

3. The process of claim 2 wherein said sulfur-containing oxyacid comprises potassium monopersulfate, potassium dipersulfate, or mixtures thereof and preferably comprises a triple salt having the formula of 2 KHSO₅.KHSO₄.K₂SO₄.

4. The process of claim 2 wherein said soluble chlorite salt is sodium chlorite.

5. The process of claim 2 wherein said alkali metal salt or alkaline earth halide salt is magnesium chloride, zinc chloride, zinc bromide, sodium chloride, or mixtures thereof; and is preferably magnesium chloride.

6. The process of claim 2 wherein said alkali metal salt or alkaline earth carbonate or bicarbonate is sodium bicarbonate.

7. The process of claim 2 wherein said composition further comprises, by weight, about 0.001 to about 10% of an alkali metal carbonate, alkaline earth metal carbonate, alkali metal bicarbonate, alkaline earth metal bicarbonate, or mixtures thereof; about 0.001 to about 15% of a binder; about 0.001 to about 5% of a lubricant; about 0.001 to about 5% of a punch face anti-adherent; about 0.001 to about 5% of a fragrance enhancer; about 0.001 to about 20% of an acid other than the oxyacid; or combinations of two or more thereof.

8. The process of claim 7 wherein said sugar alcohol is sorbitol and said lubricant is polyethylene glycol having a molecular weight of from about 3000 to about 10000.

9. The process of claim 1 wherein the water is pool water, spa water, fountain water, reflecting pool water, or ornamental pond water.

10. A process for treating pool water, spa water, fountain water, reflecting pool water, or ornamental pond water comprising contacting a tablet with said water wherein said tablet comprises, by weight, from (a) about 20% to about 90% of a sulfur-containing oxyacid comprising a triple salt having the formula of 2 KHSO₅.KHSO₄.K₂SO₄, (b) about 3% to about 25% of sodium chlorite, (c) about 3% to about 12% of magnesium chloride, and (d) from about 0.001 to about 37% of sodium sulfate, (e) from about 0.001 to about 10% of sodium bicarbonate; and (f) optionally from about 0.001 to about 15% of sorbitol; about 0.001 to about 5% of starch; about 0.001 to about 5% of polyethylene glycol; about 0.001 to about 5% of sodium benzoate; about 0.001 to about 5% of a fragrance enhancer; about 0.001 to about 20% of an acid other than the oxyacid; or combinations of two or more thereof; provided that a cation of said magnesium chloride, said bicarbonate, or both does not form a sulfate with a solubility less than 1% in water.

11. A method for clarifying water comprising a) contacting the water with a composition comprising an active oxygen compound and one or more precursors for generating chlorine dioxide, b) dissolving said composition in said water at about 25° C. in less than about 60 minutes, and c) generating a solution containing at least about 40 ppm chlorine dioxide.

12. A method for sanitizing or disinfecting water comprising a) contacting the water with a composition comprising an active oxygen compound and one or more precursors for generating chlorine dioxide, b) dissolving said composition in said water at about 25° C. in less than about 60 minutes, and c) generating a solution containing at least about 40 ppm chlorine dioxide.

13. The method of claim 11 wherein said composition comprises by weight
a) from about 20% to about 90% of a sulfur-containing oxyacid;
b) from about 3% to about 25% of a soluble chlorite salt;
c) from about 3% to about 12% of an alkali metal halide or alkaline earth metal halide, or mixtures thereof;
d) from about 0.001 to about 37% of a filler;
e) from about 0.001 to about 5% of a carbohydrate; and
f) optionally, an alkali metal carbonate, alkaline earth metal carbonate, alkali metal bicarbonate, alkaline earth metal bicarbonate, or mixtures thereof; a binder; a lubricant; a punch face anti-adherent; a fragrance enhancer; an acid other than the oxyacid; or combinations of two or more thereof;
provided that a cation of said alkali metal halide, said alkaline earth metal halide, said alkali metal carbonate, said alkaline earth metal carbonate, said alkali metal bicarbonate, said alkaline earth metal bicarbonate, or said alkaline earth bicarbonate does not form a sulfate with solubility less than 1% in water.

14. The method of claim 12 wherein said composition comprises by weight
a) from about 20% to about 90% of a sulfur-containing oxyacid;
b) from about 3% to about 25% of a soluble chlorite salt;
c) from about 3% to about 12% of an alkali metal halide or alkaline earth metal halide, or mixtures thereof;
d) from about 0.001 to about 37% of a filler,
e) from about 0.001 to about 5% of a carbohydrate; and
f) optionally, an alkali metal carbonate, alkaline earth metal carbonate, alkali metal bicarbonate, alkaline earth metal bicarbonate, or mixtures thereof; a binder; a lubricant; a punch face anti-adherent; a fragrance enhancer; an acid other than the oxyacid; or combinations of two or more thereof;
provided that a cation of said alkali metal halide, said alkaline earth metal halide, said alkali metal carbonate, said alkaline earth metal carbonate, said alkali metal bicarbonate, said alkaline earth metal bicarbonate, or said alkaline earth bicarbonate does not form a sulfate with solubility less than 1% in water.

15. A composition comprising an active oxygen compound and one or more precursors for generating chlorine dioxide wherein said composition dissolves in water at about 25° C. in less than about 60 minutes generating a solution containing at least about 40 ppm chlorine dioxide.

16. The composition of claim 15 which comprises by weight
a) from about 20% to about 90% of a sulfur-containing oxyacid;
b) from about 3% to about 25% of a soluble chlorite salt;
c) from about 3% to about 12% of an alkali metal halide or alkaline earth metal halide, or mixtures thereof;
d) from about 0.001 to about 37% of a filler;
e) from about 0.001 to about 5% of a carbohydrate; and
f) optionally, an alkali metal carbonate, alkaline earth metal carbonate, alkali metal bicarbonate, alkaline earth metal bicarbonate, or mixtures thereof; a binder; a lubricant; a punch face anti-adherent; a fragrance enhancer; an acid other than the oxyacid; or combinations of two or more thereof;
provided that a cation of said alkali metal halide, said alkaline earth metal halide, said alkali metal carbonate, said alkaline earth metal carbonate, said alkali metal bicarbonate, said alkaline earth metal bicarbonate, or said alkaline earth bicarbonate does not form a sulfate with solubility less than 1% in water.
